(19) United States
(12) Patent Application Publication
(10) Pub. No.: US 2014/0187399 A1
(43) Pub. Date: Jul. 3, 2014

(54) BAG SEALING MACHINE

(71) Applicant: CHAN LI MACHINERY CO., LTD., Taoyuan (TW)

(72) Inventor: CHI PIN HSU, Taoyuan (TW)

(21) Appl. No.: 13/912,518

(22) Filed: Jun. 7, 2013

(30) Foreign Application Priority Data
Dec. 28, 2012 (TW) 101151286

(51) Int. Cl. B31B 1/64

(52) U.S. Cl. CPC B31B 1/64
USPC 493/186

(57) ABSTRACT

A bag sealing machine includes a first rocker arm, a second rocker arm, a protective unit connecting the first rocker arm to the second rocker arm, a swing unit coupled to the second rocker arm, a first sealing unit connected to one end of the swing unit through a first link, and a second sealing unit connected to the other end of the swing unit through an actuator unit. During swinging of the first rocker arm, the first rocker arm drives the protective unit and the second rocker arm to swing the swing unit, causing the first link and the actuator unit to move the first sealing unit and the second sealing unit toward each other to squeeze the packing bag and to seal the packing bag thermally.

### BACKGROUND OF THE INVENTION

1. Technical Field

The present invention relates to a bag sealing technology and more particularly, to a bag sealing machine, which enhances the sealing yield and prolongs the machine lifespan.

2. Description of the Prior Art

Referring to FIGS. 1 and 2, a side view and a front view of a conventional bag sealing machine are illustrated. As illustrated, the bag sealing machine 10 comprises a first rocker arm 111, a second rocker arm 113, a protective air cylinder 131, a working air cylinder 133, two swing units 15, two first links 171, two second links 173, a first sealing unit 191, and a second sealing unit 193.

The protective air cylinder 131 and the working air cylinder 133 are connected together. The first rocker arm 111 is connected to the second rocker arm 113 through the protective air cylinder 131 and the working air cylinder 133. When swinging the first rocker arm 111, the first rocker arm 111 will drive the protective air cylinder 131 and the working air cylinder 133 to swing the second rocker arm 113.

The second rocker arm 113 is connected to the axis of the swing unit 15. When swinging the second rocker arm 113, the second rocker arm 113 will drive the swing unit 15 to swing. The swing unit 15 has its two opposite ends respectively connected to the first link 171 and the second link 173. Thus, when swinging the swing unit 15, the first link 171 and the second link 173 will be moved by the swing unit 15.

The first link 71 has its one end connected to the swing unit 15, and its other end connected to the first sealing unit 191. The second link 173 has its one end connected to the swing unit 15, and its other end connected to the second sealing unit 193. When swinging the swing unit 15, the first link 171 and the second link 173 will be driven by the swing unit 15 to move the first sealing unit 191 and the second sealing unit 19 in reversed directions.

During application of the bag sealing machine 10, the first sealing unit 191 is kept below the second sealing unit 193. By means of swinging the first rocker arm 111, the first sealing unit 191 and the second sealing unit 193 are alternatively moved between an open position and a close position. As shown in FIG. 1, the first rocker arm 111 can drive the first sealing unit 191 to move downward and the second sealing unit 193 to move upward, increasing the gap 14 between the first sealing unit 191 and the second sealing unit 193. When the gap 14 between the first sealing unit 191 and the second sealing unit 193 surpasses a predetermined value, a packing bag 12 can be transferred to pass through the gap 14 between the first sealing unit 191 and the second sealing unit 193.

During the operation of the first rocker arm 111 to move the first sealing unit 191 upward and the second sealing unit 193 downward, the working air cylinder 133 will extend to push the second rocker arm 113, forcing the second rocker arm 113 to swing the swing unit 15. Thus, the working air cylinder 133 can drive the first sealing unit 191 to move downward and the second sealing unit 193 to move upward, increasing the gap 14 between the first sealing unit 191 and the second sealing unit 193 for the passing of the packing bag 12.

Referring to FIG. 3, after the packing bag 12 is transferred to a predetermined position, the first rocker arm 111 will drive the first sealing unit 191 to move upward and the second sealing unit 193 to move downward, shortening the gap 14 between the first sealing unit 191 and the second sealing unit 193. As soon as the first sealing unit 191 and the second sealing unit 193 touch the packing bag 12, the first sealing unit 191 and the second sealing unit 193 are controlled to heat the packing bag 12, causing the packing bag 12 to be thermally sealed. Thus, the packing bag sealing process is done.

When driving the first rocker arm 11 to move the first sealing unit 191 upward and the second sealing unit 193 downward, the working air cylinder 133 will retract to pull the second rocker arm 113, causing the second rocker arm 113 to swing the swing unit 15. Thus, the working air cylinder 133 can drive the first sealing unit 191 to move upward and the second sealing unit 193 to move downward, forcing the first sealing unit 191 and the second sealing unit 193 against the packing bag 12, enhancing the heat-sealing performance.

Using the working air cylinder 133 to assist the first rocker arm 111 in moving the first sealing unit 191 and the second sealing unit 193 can buffer the impact between the first sealing unit 191 and the second sealing unit 193, reducing the damage caused by the impact between the first sealing unit 191 and the second sealing unit 193. The protective air cylinder 131 is adapted to protect the structure of the bag sealing machine 10. If the bag sealing machine 10 works abnormally, the protective air cylinder 131 will extend or retract, preventing machine structural damage.

Although using the protective air cylinder 131 and the working air cylinder 133 can protect the bag sealing machine 10 and improve the production yield of the bag sealing machine 10, the bag sealing machine 10 still has certain drawbacks that can affect the production yield, or cause machine damage.

### SUMMARY OF THE PRESENT INVENTION

It is, therefore, the main object of the present invention to provide a bag sealing machine, which enables an actuator unit to simply drive one single sealing unit, reducing the burden on the actuator unit and the change of damage to the actuator unit.

It is another object of the present invention to provide a bag sealing machine, which uses two actuator units to link and drive one single sealing unit, enhancing the performance of the actuator units and enabling the sealing units to squeeze the packing bag tightly and to seal the packing bag positive, so that the sealing yield and sealing quality are improved.

It is still another object of the present invention to provide a bag sealing machine, which uses two actuator units to link and drive one single sealing unit, allowing the use of a protective unit having a relatively lower load-bearing capacity to provide better protection to the bag sealing machine and to reduce the chance of damage to the bag sealing machine and the machine maintenance cost.

To achieve the above mentioned and other objectives, the present invention provides a bag sealing machine, comprising: a first rocker arm; a second rocker arm; a protective unit set between the first rocker arm and the second rocker arm and drivable by the first rocker arm to swing the second rocker arm; at least one swing unit connected to the second rocker arm and drivable by the second rocker arm to swing as the second rocker arm swings; a first sealing unit; a second sealing unit disposed opposing the first sealing unit and workable with the first sealing unit to seal a packing bag therebetween; at least one first link connected to the at least one swing unit and the first sealing unit and drivable by the at least one swing unit to move the first sealing unit as the at least one swing unit swings; and at least one actuator unit set between the at least one swing unit and the second sealing unit and drivable by the at least one swing unit to move the second sealing unit relative to the first sealing unit as the at least one swing unit swings.

In one embodiment of the bag sealing machine, wherein the mount of the at least one swing unit, the amount of the first link and the amount of the at least one actuator unit are two.

In one embodiment of the bag sealing machine, further comprising at least one second link connected to the actuator unit and the second sealing unit.

In one embodiment of the bag sealing machine, further comprising a connection rod adapted to connect the second rocker arm to the two swing units.

In one embodiment of the bag sealing machine, wherein the protective unit is a protective air cylinder, and each the actuator unit is a working air cylinder.

In one embodiment of the bag sealing machine, wherein the first sealing unit comprises a first gripping device and a first heating device, and the second sealing unit comprises a second gripping device and a second heating device.

In one embodiment of the bag sealing machine, wherein the first gripping device and the second gripping device are adapted to grip a packing bag therebetween for enabling the first heat device and the second heating device to heat-seal the packing bag between the first gripping device and the second gripping device.

In one embodiment of the bag sealing machine, wherein one the first sealing unit and the second sealing unit comprises a cutter adapted for cutting off the packing bag being sealed therebetween.

In one embodiment of the bag sealing machine, wherein each the swing unit comprises a pivot portion; the second rocker arm is connected to the pivot portion of one the swing unit; each the first link and each the actuator are respectively connected to two opposite sides of the pivot portion of one the swing unit.

In one embodiment of the bag sealing machine, wherein the second sealing unit is disposed above the first sealing unit.

### BRIEF DESCRIPTION OF THE DRAWINGS

FIG. 1 is a schematic side view of a bag sealing machine according to the prior art.

FIG. 2 is a front view of the bag sealing machine according to the prior art.

FIG. 3 is a schematic side view of the prior art bag sealing machine, illustrating the first sealing unit and the second sealing unit moved toward each other.

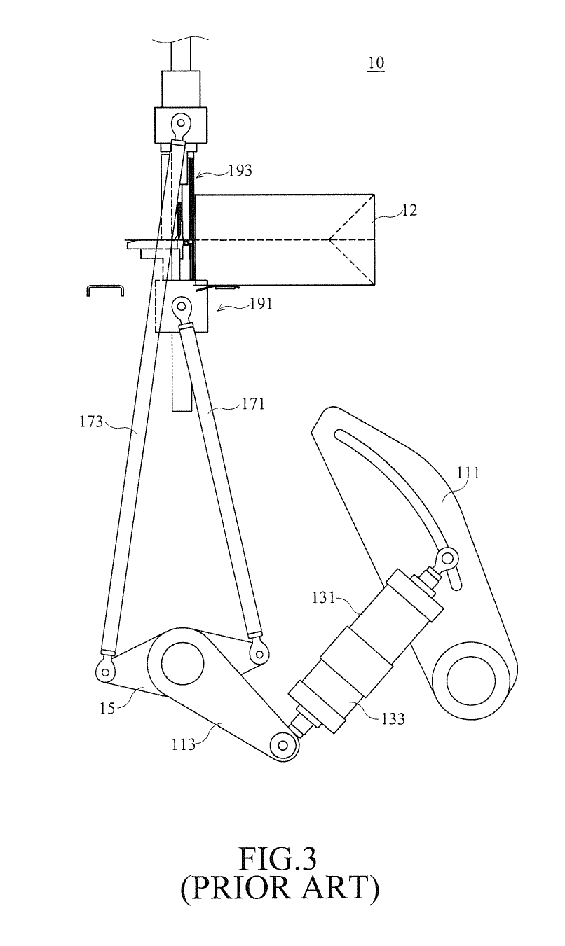

FIG. 4 is a schematic side view of a bag sealing machine in accordance with one embodiment of the present invention.

FIG. 5 is a front view of the bag sealing machine in accordance with one embodiment of the present invention.

FIG. 6 is a schematic applied view of one embodiment of the present invention, illustrating a bag feeding action of the bag sealing machine.

FIG. 7 is a schematic applied view of one embodiment of the present invention, illustrating a bag sealing action of the bag sealing machine.

### DETAILED DESCRIPTION OF THE PREFERRED EMBODIMENTS

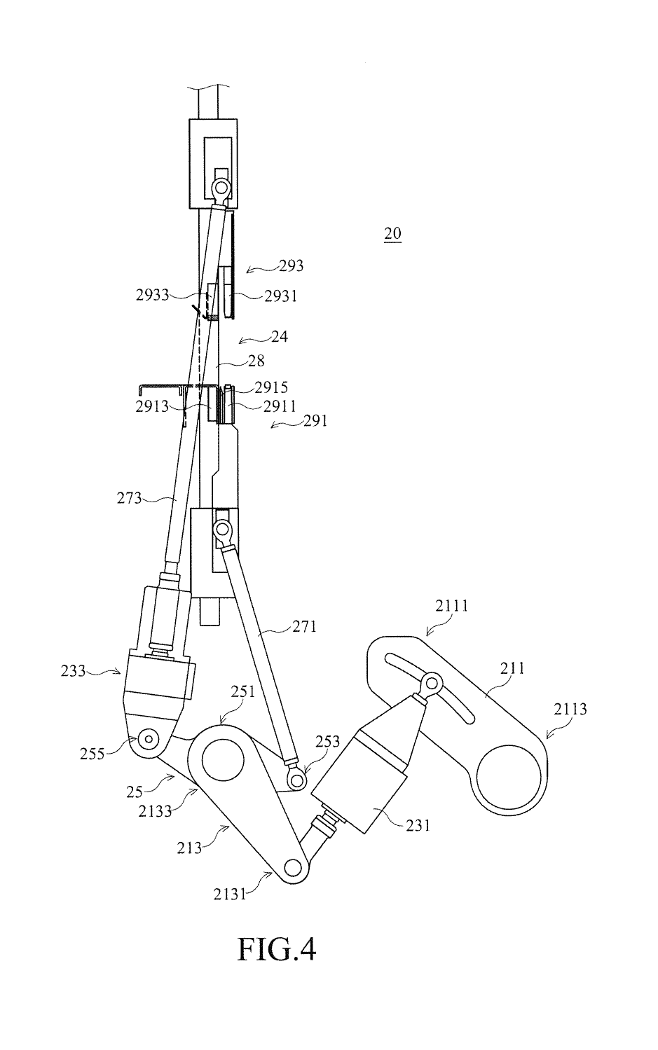

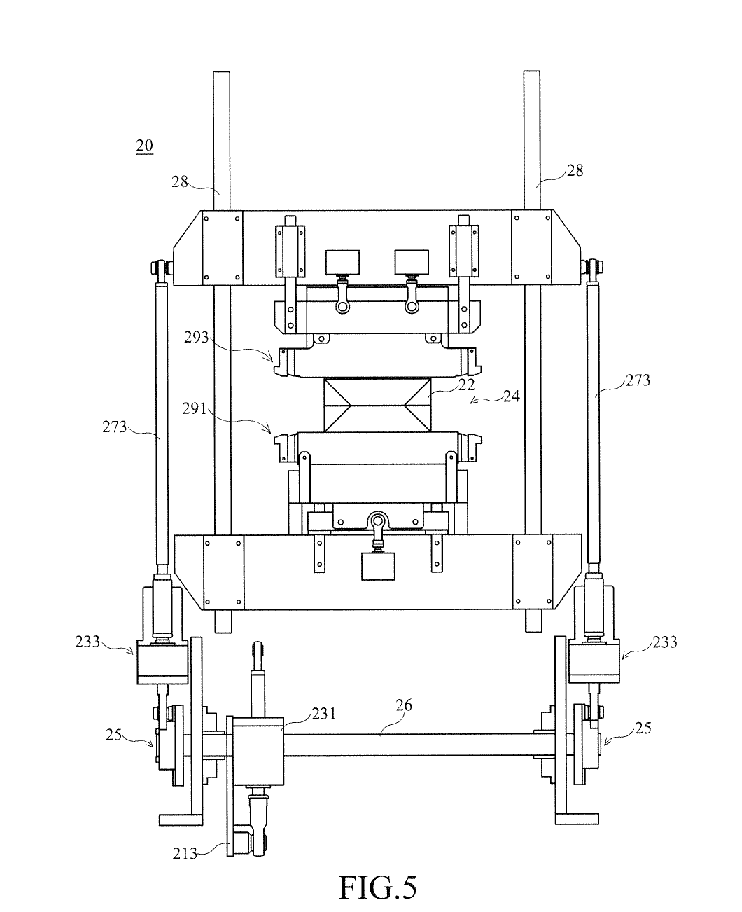

Referring to FIGS. 4 and 5, a front view and side view of a bag sealing machine in accordance with the present invention are illustrated. As illustrated, the bag sealing machine 20 comprises a first rocker arm 211, a second rocker arm 213, a protective unit 231, at least one actuator unit 233, at least one swing unit 25, at least one first rod member 271, a first sealing unit 291, and a second sealing unit 293.

The protective unit 231 has its one end connected to the first rocker arm 211 and its other end connected to the second rocker arm 213, i.e., the protective unit 231 is coupled between the first rocker arm 211 and the second rocker arm 213 and can drive the second rocker arm 213 to swing during swinging of the first rocker arm 211. In one embodiment, the first rocker arm 211 comprises a swing portion 2111 and a pivot portion 2113. A drive unit (not shown) is connected to the pivot portion 2113 of the first rocker arm 211 for driving the first rocker arm 211 to turn back and forth about the center of the pivot portion 2113.

The second rocker arm 213 has its one end connected to the protective unit 231, and its other end connected to the swing unit 25. In one embodiment, the second rocker arm 213 comprises a swing portion 2131 and a pivot portion 2133. The swing portion 2131 is connected to the protective unit 231. The pivot portion 2133 is connected to the swing unit 25, for example, the pivot portion 251 of the swing unit 25. When the first rocker arm 211 drives the second rocker arm 213 to swing, the second rocker arm 213 can drive the swing unit 25 to turn about the center of the pivot portion 251.

In one embodiment, the amount of the swing unit 25, the first link 271, the actuator unit 233 and/or the second link 273 can be two. The second rocker arm 213 connects the pivot portions 251 of two swing units 25 by a connection rod 26 so that when the first rocker arm 211 drives the second rocker arm 213 to swing, the swing unit 25 can drive the connection rod 26 to swing the two swing units 25.

The swing unit 25 has its one end connected to the first link 271, and its other end connected to the actuator unit 233. For example, the first link 271 and the actuator unit 233 are respectively connected to the first swing portion 253 and second swing portion 255 of the swing unit 25, and the first swing portion 253 and second swing portion 255 are respectively disposed at two opposite sides of the pivot portion 251. When the second rocker arm 213 drives the swing unit 25 to turn about the center of the pivot portion 251, the swing unit 25 will move the first link 271 and the actuator unit 233.

The first link 271 has its one end connected to the first swing portion 253 of the swing unit 25 and its other end connected to the first sealing unit 291, so that the swing unit 25 can move the first sealing unit 291 via the first link 271. The actuator unit 233 has its one end connected to the second swing portion 255 of the swing unit 25 and its other end connected to the second sealing unit 293 so that the swing unit 25 can move the second sealing unit 293 via the actuator unit 233.

In above embodiments, the actuator unit 233 directly connects the swing unit 25 and the second sealing unit 293. In actual application, the actuator unit 233 can be connected to the second sealing unit 293 through the second link 273, or connected to the second swing portion 255 of the swing unit 25 through the second link 273, allowing the swing unit 25 to move the second sealing unit 293 via the actuator unit 233 and the second link 273.

In one embodiment, if two swing units 25 and two actuator units 233 are used, the two swing units 25 can be connected to the two opposite ends of the second sealing unit 293 by means of the actuator unit 233 and/or the second rod member 273, and connected to the two opposite ends of the first sealing unit 291 by means of the first rod member 271, facilitating driving the first sealing unit 291 and the second sealing unit 293 to move.

The first sealing unit 291 and the second sealing unit 293 are arranged to face toward each other on one same plane. Because the first sealing unit 291 and the second sealing unit 293 are respectively connected to two opposite sides of the pivot portion 251 of the swing unit 25, the swing unit 25 can drive the first sealing unit 291 and the second sealing unit 293 to move in reversed directions. A gap 24 is defined between the first sealing unit 291 and the second sealing unit 293. By means of relative displacement between the first sealing unit 291 and the second sealing unit 293, the size of the gap 24 is relatively adjusted. In one embodiment of the present invention, the first sealing unit 291 can be disposed below the second sealing unit 293 and the swing unit 25 adapts to drive the first sealing unit 291 and the second sealing unit 293 to move up and down relative to each other, thereby sealing a packing bag 22 therebetween. This packing bag sealing process will be explained latter.

In one embodiment, the bag sealing machine 20 further comprises at least one, for example, two sliding rails 28. The first sealing unit 291 and the second sealing unit 293 are coupled to and movable along the sliding rails 28.

The first sealing unit 291 comprises a first heating device 2911 and a first gripping device 2913. The second sealing unit 293 comprises a second heating device 2931 and a second gripping device 2933. When moving the first sealing unit 291 and the second sealing unit 293 toward each other, the first gripping device 2913 and the second gripping device 2933 will grip the packing bag 22, enabling the first heating device 2911 and the second heating device 2931 to heat the packing bag 22, and therefore the packing bag 22 is thermally sealed. The first sealing unit 291 further comprises a cutter 2915 for cutting off the well sealed packing bag 22. In another embodiment of the present invention, the cutter 2915 can be mounted in the second sealing unit 293 for cutting off each sealed packing bag 22.

The actuator unit 233 is equipped with power drive means for driving the second sealing unit 293. In actual application, the actuator unit 233 works during swinging of the swing unit 25, assisting the swing unit 25 to drive the second sealing unit 293. When the swing unit 25 drives the first sealing unit 291 to move downward and the second sealing unit 293 to move upward, the actuator unit 233 extends and drives the second sealing unit 293 further upward, increasing the gap 24 between the first sealing unit 291 and the second sealing unit 293 and avoiding contact between the packing bag 22 and the second heating unit 2931 of the second sealing unit 293 to cause damage during the delivery of the packing bag 22.

Further, when the swing unit 25 drives the first sealing unit 291 to move upward and the second sealing unit 293 to move downward, the actuator unit 233 retracts and drives the second sealing unit 293 further downward, forcing the first gripping device 2913 and the second gripping device 2933 to grip the packing bag 22 tightly. This arrangement not only is conductive to the sealing process to seal the packing bag 22 but also enhances sealing yield.

The actuator unit 233 of the bag sealing machine 20 in accordance with the present invention simply works to move the second sealing unit 293. When compared to the working air cylinder 133 of the prior art design, the actuator unit 233 of the present invention bears less load, enhancing the gripping force of the first gripping device 2913 and the second gripping device 2933 to grip the packing bag 22 and reducing the chance of damage to the actuator unit 233. Further, the amount of the actuator unit 233 can be two. Using two actuator units 233 can reduce the burden on each actuator unit 233 and the chance of damage to the actuator units 233.

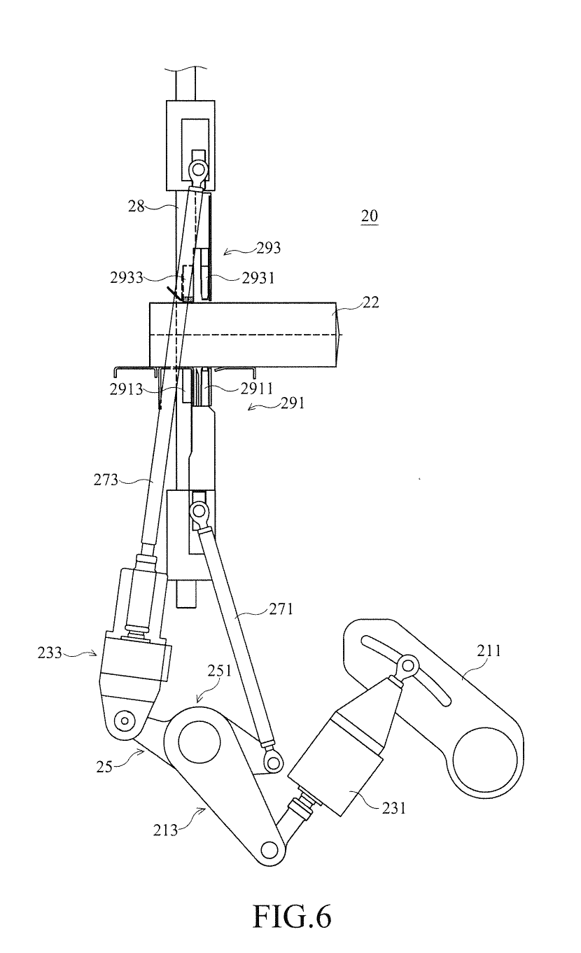

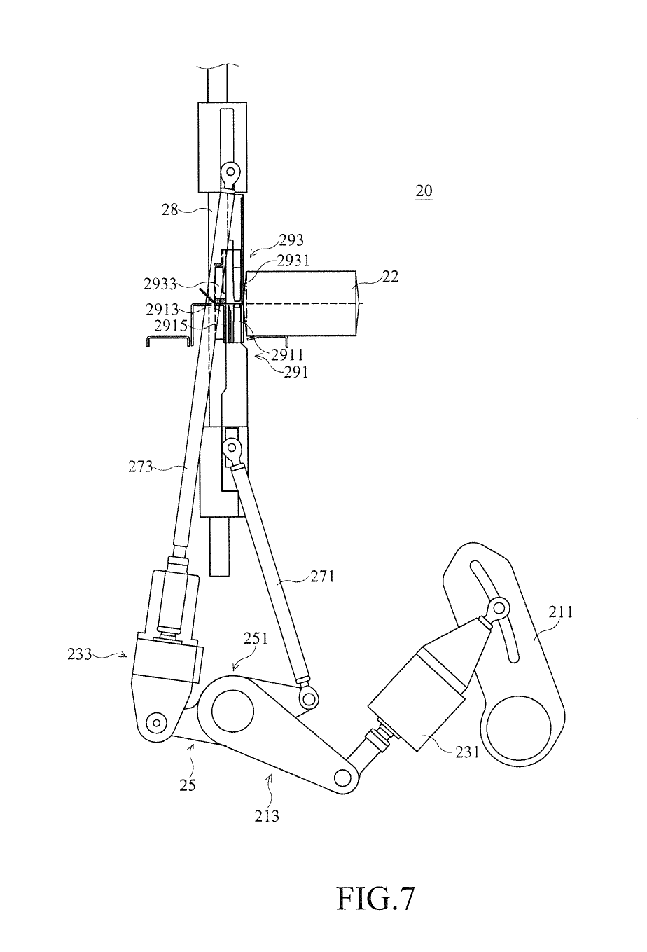

Referring to FIGS. 6 and 7, bag feeding and sealing actions of the bag sealing machine 20 are illustrated. As illustrated in FIGS. 6 and 7 and accompanying FIG. 4, when operating the bag sealing machine 20 to seal one packing bag 22, the first rocker arm 211 drives the first sealing unit 291 and the second sealing unit 293 to move apart and to increase the gap 24 between the first sealing unit 291 and the second sealing unit 293 for allowing the packing bag 22 to be delivered through the gap 24 between the first sealing unit 291 and the second sealing unit 293.

The operation in detail is outlined hereinafter. The first rocker arm 211 drives the protective unit 231 to swing the second rocker arm 213. During swinging of the second rocker arm 213, the swing unit 25 is forced to turn about the center of the pivot portion 251. When swinging the swing unit 251, the swing unit 251 drives the first link 271 and the actuator unit 233 to move the first sealing unit 291 and the second sealing unit 293. As shown in FIG. 6, the swing unit 251 drives the first link 271 to move the first sealing unit 291 downward, and the actuator unit 233 and/or the second link 273 to move the second sealing unit 293 upward. When the gap 24 between the first sealing unit 291 and the second sealing unit 293 surpasses a predetermined value, the packing bag 22 can then be delivered through the gap 24.

In one embodiment of the present invention, the actuator unit 233 can be a working air cylinder. When the swing unit 25 drives the actuator unit 233 and/or the second link 273 to move the second sealing unit 293 upward, the actuator unit 233 extends and moves the second sealing unit 293 further upward. Subject to the arrangement of the actuator unit 233, the gap 24 can be further expanded, avoiding the second heating device 2931 and/or first heating device 2911 to contact the packing bag 22 during delivery, and rendering buffer to the second sealing unit 293 to reduce the chance of damage to the second sealing unit 293.

As illustrated in FIG. 7, when the packing bag 22 reaches a predetermined position during delivery, the first rocker arm 211 will drive the protective unit 231 and the second rocker arm 213 to move the swing unit 25. The swing unit 25 will drive the first link 271 to move the first sealing unit 291 upward and drive the actuator unit 233 and/or the second link 273 to move the second sealing unit 293 downward. At this time, the first gripping device 2913 and the second gripping device 2933 will grip the packing bag 22 to hold the packing bag 22 in position. Thereafter, the first heating device 2911 and the second heating device 2931 will heat the packing bag 22, thereby sealing the packing bag 22.

During the operation of the swing unit 25 to move the first sealing unit 291 upward and the second sealing unit 293 downward, the actuator unit 233 will retract to drive the second sealing unit 293 further downward. Subject to the arrangement of the actuator unit 233, the first sealing unit 291 and the second sealing unit 293 can squeeze the packing bag 22 tightly, facilitating the first heating device 2911 and the second heating device 2931 to seal the packing bag 22 positively and to further increase the sealing yield. After the packing bag 22 is well sealed, the cutter 2915 is driven to cut off the packing bag 22.

Further, because the action of the actuator unit 233 to drive the second sealing unit 293 is much gentle than the first rocker arm 211, moving the first sealing unit 291 and the second sealing unit 293 toward each other does not produce a high pressure or sudden pressure, and therefore, the invention eliminates the probability of collision damage between the first sealing unit 291 and the second sealing unit 293.

In one embodiment of the present invention, the protective unit 231 can be a protective air cylinder, characterized in that: if the pressure being applied to the two ends of the protective unit 231 surpasses the load-bearing capacity of the air cylinder, the protective unit 231 will be forced to extend; if the pressure being applied the two ends of the protective unit 231 is below the load-bearing capacity of the air cylinder, the protective unit 231 does not extend and will work as a link to transfer the force from the first rocker arm 211 to the second rocker arm 213.

The arrangement of the protective unit 231 can protect the component parts of the bag sealing machine 20. For example, when the delivery position of the packing bag 22 is abnormal, the first sealing unit 291 and the second sealing unit 293 will grip the packaged object. If the gripping force between the first sealing unit 291 and the second sealing unit 293 surpasses the load-bearing capacity of the protective unit 231, the protective unit 231 will be forced to extend, prohibiting transfer of the force from the first rocker arm 211 through the protective unit 231 to the actuator unit 233 and protecting the component parts of the bag sealing machine 20 against damage.

Normally, when the protective unit 231 bears less pressure, it provides better protection to the bag sealing machine 20. However, it the bearing pressure of the protective unit 231 is too small, the bag sealing machine 20 will be unable to function normally.

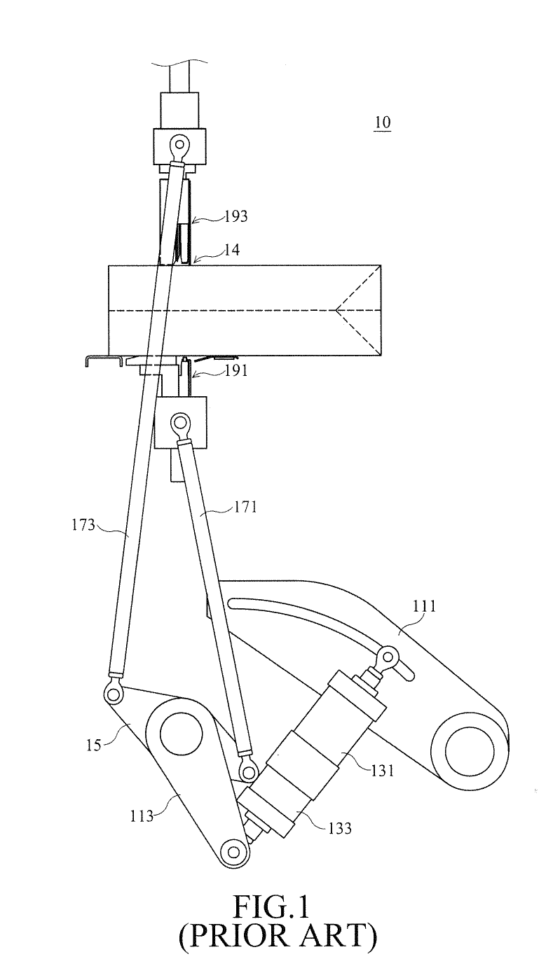

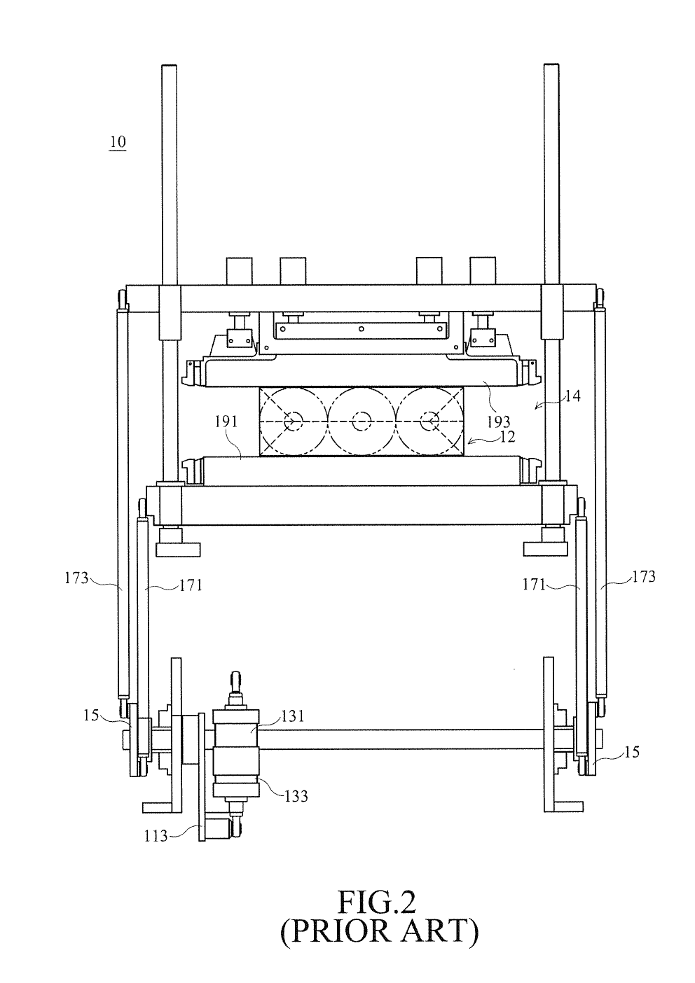

Referring to FIGS. 1 and 2, the prior art bag sealing machine 10 simply provides one single working air cylinder 133 between the protective air cylinder 131 and the second rocker arm 113 for driving the first sealing unit 191 and the second sealing unit 193 to move relative each other. At this time, this single working air cylinder 133 needs to bear the pressure of the first sealing unit 191 and the second sealing unit 193. This arrangement is not conducive to the working air cylinder 133 in driving the first sealing unit 191 and the second sealing unit 193 to grip the packing bag 12, and can cause damage to the working air cylinder 133 easily.

Further connecting the working air cylinder 133 to the protective air cylinder 131 will cause the working air cylinder 133 to transfer its received pressure to the protective air cylinder 131, increasing the burden on the protective air cylinder 131. In consequence, the protective air cylinder 131 must have a larger load-bearing capacity for enabling the force to be transferred from first rocker arm 111 through the protective air cylinder 131 to the first sealing unit 191 and the second sealing unit 193. However, when the pressure applied to the protective air cylinder 131 increases, the protection provided by the protective air cylinder 131 to the bag sealing machine 10 will be reduced.

When compared to the prior art design, the actuator unit 233 of the bag sealing machine 20 in accordance with the present invention does not connect the protective unit 231 directly, and the actuator unit 233 is simply adapted to move the second sealing unit 293 without bearing the pressure of the first sealing unit 291, and therefore the burden on the actuator unit 233 can be reduced, reducing the change of damage to the actuator unit 233. In consequence, the actuator unit 293 can drive the second sealing unit 293 more easily, forcing the first gripping device 2913 and the second gripping device 2933 to squeeze the packing bag 22 tightly and to seal the packing bag 22 positively. Further, reducing the burden on the actuator unit 293 enables the protective unit 291 to bear less pressure and to provide better protection to the bag sealing machine 20.

In one preferred embodiment of the present invention, as shown in FIG. 5, the bag sealing machine 20 comprises two swing units 251 and two actuator units 233, wherein the two actuator units 233 are respectively connected to the two opposite ends of the second sealing unit 293 and adapted to move the second sealing unit 293. Because two actuator units 233 are used and adapted to move second sealing unit 293 at the same time, each individual actuator unit 233 bears less pressure.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bag sealing machine, comprising:
a first rocker arm;
a second rocker arm;
a protective unit set between said first rocker arm and said second rocker arm and drivable by said first rocker arm to swing said second rocker arm;
at least one swing unit connected to said second rocker arm and drivable by said second rocker arm to swing as said second rocker arm swings;
a first sealing unit;
a second sealing unit disposed opposing said first sealing unit and workable with said first sealing unit to seal a packing bag therebetween;
at least one first link connected to said at least one swing unit and said first sealing unit and drivable by said at least one swing unit to move said first sealing unit as said at least one swing unit swings; and
at least one actuator unit set between said at least one swing unit and said second sealing unit and drivable by said at least one swing unit to move said second sealing unit relative to said first sealing unit as said at least one swing unit swings.

2. The bag sealing machine as claimed in claim 1, wherein the mount of said at least one swing unit, the amount of said first link and the amount of said at least one actuator unit are two.

3. The bag sealing machine as claimed in claim 2, further comprising at least one second link connected to said actuator unit and said second sealing unit.

4. The bag sealing machine as claimed in claim 2, further comprising a connection rod adapted to connect said second rocker arm to said two swing units.

5. The bag sealing machine as claimed in claim 1, wherein said protective unit is a protective air cylinder, and each said actuator unit is a working air cylinder.

6. The bag sealing machine as claimed in claim 1, wherein said first sealing unit comprises a first gripping device and a first heating device, and said second sealing unit comprises a second gripping device and a second heating device.

7. The bag sealing machine as claimed in claim 6, wherein said first gripping device and said second gripping device are adapted to grip a packing bag therebetween for enabling said first heat device and said second heating device to heat-seal said packing bag between said first gripping device and said second gripping device.

8. The bag sealing machine as claimed in claim 6, wherein one said first sealing unit and said second sealing unit comprises a cutter adapted for cutting off the packing bag being sealed therebetween.

9. The bag sealing machine as claimed in claim 1, wherein each said swing unit comprises a pivot portion; said second rocker arm is connected to the pivot portion of one said swing unit; each said first link and each said actuator are respectively connected to two opposite sides of the pivot portion of one said swing unit.

10. The bag sealing machine as claimed in claim 1, wherein said second sealing unit is disposed above said first sealing unit.
